(19) United States
(12) Patent Application Publication
(10) Pub. No.: US 2025/0290602 A1
(43) Pub. Date: Sep. 18, 2025

(54) LIQUID HYDROGEN PRESSURIZATION AND REFUELING SYSTEM SYNERGISTICALLY DRIVEN BY POWER AND HEAT

(71) Applicant: ZHEJIANG UNIVERSITY, HANGZHOU, Zhejiang Province (CN)

(72) Inventors: KAI WANG, HANGZHOU, ZHEJIANG PROVINCE (CN); GUOYI QIU, HANGZHOU, ZHEJIANG PROVINCE (CN); LINXIN DONG, HANGZHOU, ZHEJIANG PROVINCE (CN); LIMIN QIU, HANGZHOU, ZHEJIANG PROVINCE (CN)

(21) Appl. No.: 18/860,579

(22) PCT Filed: Dec. 19, 2023
(86) PCT No.: PCT/CN2023/139758

§ 371 Date: Oct. 25, 2024

(30) Foreign Application Priority Data
Mar. 9, 2023 (CN) 202310220777.8

(51) Int. Cl. F17C 5/00

(52) U.S. Cl. CPC F17C 5/007; F17C 2205/0323; F17C 2205/0352; F17C 2221/012; F17C 2223/0161; F17C 2223/036; F17C 2227/0142; F17C 2227/0302; F17C 2227/0374; F17C 2227/043; F17C 2250/043; F17C 2250/0439; F17C 2265/065; F17C 2270/0178

(57) ABSTRACT

The present invention discloses a liquid hydrogen pressurization and refueling system synergistically driven by power and heat, at its core is a cascaded cryogenic and high-pressure vessel group, which achieves staged pressurization of liquid hydrogen to 80-100 MPa by combining reciprocating liquid hydrogen pump pressurization and equal-capacity thermal compression using cryogenic and high-pressure vessels, the filling of a vehicle-mounted storage tank occurs through these cascaded vessels; the pressurization and filling processes are closely integrated, with hydrogen flow in the filling process serving as a heat-transfer medium. Efficient in-tank thermal compression of the cryogenic and high-pressure vessels is achieved without additional driving force. Based on the combination of efficient low-pressure compression using the liquid hydrogen pump and high-pressure thermal compression without power consumption, the present invention fully utilized liquid hydrogen cooling capacity to replace the high pump power consumption typically required in the traditional pressurization process; and a cascaded storage tank is combined to reduce the exergy loss in the filling process, resulting in low-energy-consumption continuous filling of the liquid hydrogen refueling station.

### TECHNICAL FIELD

The present invention belongs to the technical field of hydrogen fuel refueling, and particularly relates to a liquid hydrogen pressurization and refueling system synergistically driven by power and heat.

### BACKGROUND TECHNOLOGY

Liquid hydrogen refueling stations have the advantages of small space requirement and high capacity, making them more suitable for large-scale hydrogen refueling needs compared to high-pressure gaseous hydrogen refueling stations. Based on the pressurization method, liquid hydrogen refueling stations can be categorized into gas-state pressurization stations and liquid-type pressurization stations, utilizing compressors and high-pressure liquid hydrogen pumps, respectively. Liquid pressurization is more efficient and eliminates the need for pre-cooling, resulting in lower power consumption per unit mass for stations using high-pressure liquid hydrogen pumps.

For example, the Chinese patent document CN 115355440 A discloses cryogenic and high-pressure hydrogen mixed filling type hydrogen refueling station. This station includes a liquid hydrogen storage tank, a cryogenic saturated hydrogen transmission pipeline, a liquid hydrogen booster pump, a first cryogenic and high-pressure hydrogen transmission pipeline, a second cryogenic and high-pressure hydrogen transmission pipeline, a regenerator, an ultrahigh-pressure gasifier, an ultrahigh-pressure heater, a cryogenic and high-pressure hydrogen storage tank, a cryogenic and high-pressure hydrogen filling unit, a first ambient-temperature and high-pressure hydrogen storage tank, and a first hydrogen filling unit. This setup allows for multiple storage forms, including liquid hydrogen, cryogenic and high-pressure hydrogen, and ambient-temperature and high-pressure hydrogen. It also supports mixed filling of cryogenic and high-pressure hydrogen up to 100 MPa, as well as high-pressure hydrogen at 35 MPa and 70 MPa.

The Chinese patent document CN 113483259 A discloses a mixed filling system for hydrogen refueling stations with liquid hydrogen storage. This system includes a 35 MPa hydrogen filling unit and a 70 MPa hydrogen filling unit, both connected to a liquid hydrogen storage tank. Each filling unit features a liquid hydrogen pump that communicates with the liquid hydrogen storage tank.

Although high-pressure liquid hydrogen pumps can achieve lower compression power consumption compared to hydrogen compressors, the performance significantly deteriorates under high-pressure conditions of 90 MPa. The leakage and friction losses of these pumps increase greatly, leading to actual power consumption that is much higher than the theoretical value.

Thermal compression is a pressurization method that does not require mechanical driving. In this process, liquid hydrogen in the closed cryogenic and high-pressure storage tank is isochorically heated to increase the pressure. However, existing thermal compression processes have significant drawbacks. Residual hydrogen in a vessel after filling cannot be fully utilized through thermal compression alone, resulting in over 30% of the hydrogen being discharged into the atmosphere. Additionally, continuous and rapid filling is challenging to achieve with thermal compression. Consequently, thermal compression is difficult to apply effectively in actual liquid hydrogen refueling stations.

In summary, traditional mechanical methods for pressurizing liquid hydrogen using high-pressure liquid hydrogen pumps suffer from significant performance degradation and remain challenging to further reduce energy consumption under high-pressure operating conditions. Thermal compression methods without mechanical work may reduce energy consumption but face issues such as significant hydrogen discharge and slow pressurization speeds. Therefore, it is urgent to explore new, low-energy-consumption methods for filling liquid hydrogen.

### SUMMARY OF THE INVENTION

The present invention provides a liquid hydrogen pressurization and refueling system synergistically driven by power and heat, which can achieve low-energy-consumption filling of a liquid hydrogen refueling station by using an efficient liquid hydrogen pump in a low-pressure zone (below 50 MPa) and thermal compression method without power consumption in a high-pressure zone (below 100 MPa).

The liquid hydrogen pressurization and refueling system synergistically driven by power and heat, comprisING a liquid hydrogen storage tank, a reciprocating liquid hydrogen pump, and a cascaded cryogenic and high-pressure vessel group. The cascaded cryogenic and high-pressure vessel group includes at least four cryogenic and high-pressure vessels with identical structures.

Each of the cryogenic and high-pressure vessels is provided with an input pipeline, an output pipeline, and a return pipeline. Additionally, an in-tank heat exchanger is installed inside each cryogenic and high-pressure vessel.

Each of the input pipelines is connected to an input main pipe through an input regulating valve. Each of the output pipelines is connected to an output main pipe through an output regulating valve. Each of the return pipelines is connected to a return main pipe through a return regulating valve. An inlet end of each in-tank heat exchanger is connected to a heat exchanger main input pipe through a heat exchanger regulating valve, and an outlet end is connected to a heat exchanger main output pipe.

One end of the input main pipe is connected to the outlet of the liquid hydrogen storage tank through the reciprocating liquid hydrogen pump, while the other end is equipped with an input main pipe safety valve.

One end of the return main pipe is connected to an inlet of the liquid hydrogen storage tank through a main return regulating valve, while the other end is equipped with a return main pipe safety valve.

The tail end of the output main pipe is sequentially connected to a first three-way valve, a second three-way valve, and a first air heat exchanger. An outlet of the first air heat exchanger and the bypass of the second three-way valve are joined and then connected to the heat exchanger main input pipe.

A bypass of the first three-way valve and the tail end of the heat exchanger main output pipe are joined to a filling pipeline. The filling pipeline is sequentially connected to a third three-way valve and a second air heat exchanger. An outlet of the second air heat exchanger and the bypass of the third three-way valve are joined and then connected to a vehicle-mounted storage tank.

According to the present invention, the cascaded cryogenic and high-pressure vessel group serves as a system core, by combining pressurization through the reciprocating liquid hydrogen pump and equal-capacity thermal compression through the cryogenic and high-pressure vessels, staged pressurization of liquid hydrogen to 80-100 MPa is achieved, and the filling of the vehicle-mounted storage tank is performed in the form of the cascaded cryogenic and high-pressure vessels. A pressurization process and a filling process are deeply coupled, a hydrogen flow in the filling process serves as a heat-transfer medium, and efficient in-tank thermal compression of the cryogenic and high-pressure vessels is achieved without an extra driving force.

In the present invention, two three-way valves are provided in front of the first air heat exchanger and are respectively configured to bypass the air heat exchanger and an entire heat exchange pressurization loop, to regulate the heat exchange amount of the first air heat exchanger and the in-tank heat exchangers. The third three-way valve provided in front of the second air heat exchanger is configured to bypass the second air heat exchanger to regulate the temperature of a filling fluid.

Further, the liquid hydrogen storage tank is provided with a safety valve, and the vehicle-mounted storage tank is provided with a discharging regulating valve.

Further, the liquid hydrogen storage tank is provided with a pressure sensor. Temperature and pressure sensors are connected to each of the cryogenic and high-pressure vessels and the vehicle-mounted storage tank. Temperature sensors are respectively connected to the front and rear of each of the in-tank heat exchangers. Data measured by the sensors are transmitted to a control center in real time and are used for controlling the operation of the reciprocating liquid hydrogen pump and the regulating valves.

Optionally, the cascaded cryogenic and high-pressure vessel group comprises four cryogenic and high-pressure vessels. Three of the cryogenic and high-pressure vessels are used in the filling process, configured for cascaded filling of the vehicle-mounted storage tank. They correspond to a high-pressure vessel (with a pressure higher than the upper-pressure limit required for filling the vehicle-mounted storage tank), a medium-pressure vessel and a low-pressure vessel (with a pressure higher than the lower pressure limit required for filling the vehicle-mounted storage tank). The remaining cryogenic and high-pressure vessel is used in a power-heat cooperatively-driven pressurization process. Liquid hydrogen from the storage tank is pressurized and filled into the cryogenic and high-pressure vessel using the reciprocating liquid hydrogen pump until the pressure rises to 30-50 MPa. Then, the the liquid hydrogen is subjected to equal-capacity heating, boosting the pressure to 80-100 MPa using in-tank heat exchangers. During the equal-capacity heating process, pressurization of the cryogenic and high-pressure vessel is achieved by the hydrogen flow from the vessels in the filling process to the vehicle-mounted storage tank.

The specific process of the equal-capacity heating boosting to 80-100 MPa is as follows:

In the beginning, the filling is performed using the cryogenic and high-pressure vessel with the lowest pressure in the filling process. Supercritical hydrogen enters the first air heat exchanger through the output regulating valve to be heated to near-ambient temperature. Then, the supercritical hydrogen enters the in-tank heat exchanger of the cryogenic and high-pressure vessel in the pressurization process through the heat exchanger regulating valve, thereby performing equal-capacity pressurization on the cryogenic and high-pressure vessel in the pressurization process until the pressure reaches 80-100 MPa.

After coming out of the in-tank heat exchanger, the supercritical hydrogen flow is heated to the temperature required for filling via the third three-way valve and the second air heat exchanger, and then fills the vehicle-mounted storage tank. The output temperature of the first air heat exchanger is regulated by the second three-way valve. When the cryogenic and high-pressure vessel in the pressurization process reaches 80-100 MPa, the hydrogen flow for filling is directly guided to the in-tank heat exchanger by the first three-way valve.

When the pressure of the cryogenic and high-pressure vessel used for high-pressure filling drops below the upper pressure limit required for filling the vehicle-mounted storage tank (e.g., 75 MPa), or the pressure of the cryogenic and high-pressure vessel used for low-pressure filling drops below the lower pressure limit required for filling the vehicle-mounted storage tank (e.g., 75 MPa), the functions of the four vessels are simultaneously adjusted. The original vessel in the pressurization process becomes the high-pressure vessel in the filling process. The original high-pressure vessel in the filling process becomes the medium-pressure vessel. The original medium-pressure vessel becomes the low-pressure vessel. The original low-pressure vessel in the filling process enters the pressurization process. Through the coupling and matching of the pressurization process and the cascaded filling process, synchronization of the pressurization and filling cycles of the cryogenic and high-pressure vessels is achieved, enabling continuous and rapid pressurization filling.

Optionally, each in-tank heat exchanger is configured either as a wound pipe located outside the inner tank of the cryogenic and high-pressure vessel, or embedded within the inner tank in the form of a finned-pipe heat exchanger or a corrugated-pipe heat exchanger.

Preferably, the reciprocating liquid hydrogen pump operates at 30-50 MPa and is driven by either electric motor or hydraulic pressure.

Compared with prior art, the present invention offers the following advantageous effects:
1. According to the present invention, a liquid hydrogen pump is utilized for pressurization below 50 MPa, while heat exchangers are employed for pressurization above 50 MPa. Additionally, a common and highly efficient 50 MPa liquid hydrogen pump, widely available in the market with mature technology, replaces the technically complex and energy-intensive 90 MPa high-pressure liquid hydrogen pump. Currently, only a few manufacturers offer mature products of the 90 MPa high-pressure liquid hydrogen pump. This approach reduces equipment investment costs and achieves low-energy-consumption filling of the liquid hydrogen refueling station.
2. According to the present invention, by combining efficient low-pressure compression using a liquid hydrogen pump with high-pressure thermal compression that requires no power consumption, step-by-step pressurization is achieved. These advantages complement each other: the cooling capacity of liquid hydrogen is fully utilized to replace high pump power consumption typically required in a traditional pressurization process. Additionally, cascaded storage tanks are employed to reduce the exergy loss during the filling process, significantly reducing the filling energy consumption of the liquid hydrogen refueling station.

### BRIEF DESCRIPTION OF THE DRAWINGS

FIG. 1 shows the comprehensive structural schematic diagram of a liquid hydrogen pressurization and refueling system synergistically driven by power and heat.

### DETAILED DESCRIPTION OF EMBODIMENTS

The present invention is further described in detail in conjunction with the accompanying drawing and embodiments below. It should be pointed out that the following embodiments are intended to facilitate the understanding of the present invention and do not impose any limitations on its scope.

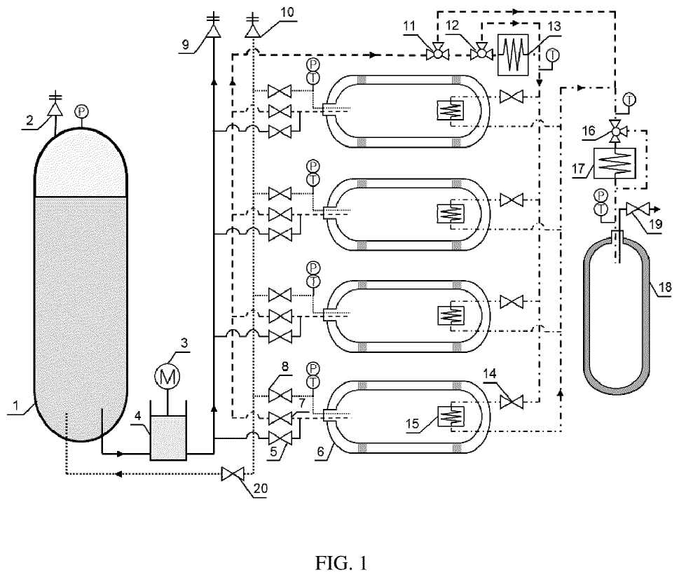

As shown in FIG. 1, a liquid hydrogen pressurization and refueling system synergistically driven by power and heat includes a liquid hydrogen storage tank 1, a liquid hydrogen storage tank safety valve 2, an electric motor 3, a reciprocating liquid hydrogen pump 4, an input regulating valve 5, a cryogenic and high-pressure vessel 6, an output regulating valve 7, a return regulating valve 8, an input main pipe safety valve 9, a return main pipe safety valve 10, a first three-way valve 11, a second three-way valve 12, a first air heat exchanger 13, a heat exchanger regulating valve 14, an in-tank heat exchanger 15, a third three-way valve 16, a second air heat exchanger 17, a vehicle-mounted storage tank 18, a discharging regulating valve 19 and a main return regulating valve 20.

Each of the cryogenic and high-pressure vessels 6 is equipped with an input pipeline, an output pipeline, and a return pipeline. The in-tank heat exchanger 15 is installed inside the cryogenic and high-pressure vessel 6. Each input pipeline is connected to an input main pipe via the input regulating valve 5. Each output pipeline is connected to an output main pipe via the output regulating valve 7. Each return pipeline is connected to a return main pipe via the return regulating valve 8. The inlet end of each in-tank heat exchanger 15 is connected to a heat exchanger main input pipe through the heat exchanger regulating valve 14, and an outlet end is connected to a heat exchanger main output pipe.

One end of the input main pipe is connected to the outlet of the liquid hydrogen storage tank 1 through the reciprocating liquid hydrogen pump 4, while the other end is equipped with the input main pipe safety valve 9. One end of the return main pipe is connected to the inlet of the liquid hydrogen storage tank 1 via the main return regulating valve 20, and the other end is equipped with the return main pipe safety valve 10. The tail end of the output main pipe is sequentially connected to the first three-way valve 11, the second three-way valve 12, and the first air heat exchanger 13. The outlet of the first air heat exchanger 13 and a bypass of the second three-way valve 12 are joined and then connected to the heat exchanger main input pipe.

The bypass of the first three-way valve 11 and the tail end of the heat exchanger main output pipe are joined to a filling pipeline. This filling pipeline is sequentially connected to the third three-way valve 16 and the second air heat exchanger 17. The outlet of the second air heat exchanger 17 and a bypass of the third three-way valve 16 are joined and then connected to the vehicle-mounted storage tank 18.

In this embodiment of the present invention, four cryogenic and high-pressure vessels 6 are used as examples, representing the minimum requirements for implementing the process. Three of the cryogenic and high-pressure vessels 6 are in the filling process, operating at high pressure, medium pressure, and low pressure respectively, to facilitate graded filling of the vehicle-mounted storage tank 18. Meanwhile, the remaining cryogenic and high-pressure vessels 6 are in a pressurization process synergistically driven by power and heat. Here, the reciprocating liquid hydrogen pump 4, driven by the electric motor 3, pressurizes liquid hydrogen from the liquid hydrogen storage tank 1 into the cryogenic and high-pressure vessel 6 in the pressurization process until the pressure reaches 50 MPa.

In the present invention, the thermal compression of the cryogenic and high-pressure vessel 6 in the pressurization process is achieved through a hydrogen flow filling the vehicle-mounted storage tank 18 from the cryogenic and high-pressure vessels 6 in the filling process. Initially, filling starts with the cryogenic and high-pressure vessel 6 which has the lowest pressure in the filling process. Supercritical hydrogen from this vessel enters the first air heat exchanger 13 via the output regulating valve 7, where it is heated close to ambient temperature. Subsequently, it enters the in-tank heat exchanger 15 of the cryogenic and high-pressure vessel 6 in the pressurization process via the heat exchanger regulating valve 14, enabling equal-capacity pressurization until the vessels reach 90 MPa. Upon exiting the in-tank heat exchanger 15, the supercritical hydrogen flow is heated to the required temperature for filling through the third three-way valve 16 and the second air heat exchanger 17 before being directed into the vehicle-mounted storage tank 18. The output temperature of the first air heat exchanger 13 can be adjusted using the second three-way valve 12. Once the cryogenic and high-pressure vessel 6 in the pressurization process reaches 90 MPa, the hydrogen flow for filling is directly routed to the in-tank heat exchanger 15 via the first three-way valve 11.

When the pressure in the cryogenic and high-pressure vessel 6 designated for high-pressure filling drops below 75 MPa, or the pressure of the cryogenic and high-pressure vessel 6 designated for low-pressure filling drops below 10 MPa, the functions of all four cryogenic and high-pressure vessels 6 are adjusted simultaneously. The original cryogenic and high-pressure vessel 6 used for high-pressure filling switches to medium-pressure filling. The original cryogenic and high-pressure vessel 6 used for medium-pressure filling switches to low-pressure filling. The original cryogenic and high-pressure vessel 6 used for low-pressure filling switches into the pressurization process. The original cryogenic and high-pressure vessel 6 in the pressurization process switches to high-pressure filling. Through coupling and matching of the pressurization process and the cascaded filling process, synchronization of pressurization and a filling cycle of the cryogenic and high-pressure vessels 6 can be achieved. This enables continuous and rapid pressurization and filling operations.

When there is no filling requirement at a hydrogen refueling station for an extended period, the cryogenic and high-pressure vessels 6 may experience temperature and pressure increases due to heat leakage. In extreme cases, this could cause the pressure to exceed the design limits of the vessels. If a cryogenic and high-pressure vessel 6 reaches excessively high pressure, it can release pressure to other vessels 6 using the return regulating valves 8 and the return main pipe. Additionally, pressure can be released to the liquid hydrogen storage tank 1 through the main return regulating valve 20. These mechanisms help prevent the vessels from exceeding safe operating pressures during periods of inactivity.

In extreme cases, when the pressure of the liquid hydrogen storage tank 1 is excessively high, the pressure can be released to the atmosphere through the liquid hydrogen storage tank safety valve 2. During the filling process of the reciprocating liquid hydrogen pump 4, if the pressure of the cryogenic and high-pressure vessel 6 being filled is excessively high, the pressure can be released to the atmosphere through the input main pipe safety valve 9. When the pressure of any of the cryogenic and high-pressure vessels 6 is excessively high, the pressure can be released to the atmosphere through the return regulating valve 8 and the return main pipe safety valve 10.

In an actual application process, the cryogenic and high-pressure vessels 6 can be of various types such as I-type, II-type, III-type, or IV-type, and the number of vessels 6 can be increased according to requirements. Each in-tank heat exchanger 15 can be configured as a wound pipe located outside the inner tank of the cryogenic and high-pressure vessel, or it could be embedded into the inner tank in the form of a finned-pipe heat exchanger or a corrugated-pipe heat exchanger. Each cryogenic and high-pressure vessel 6 can be provided with a plurality of heat exchange pressurization loops according to heat exchange requirements, to meet the requirement for rapid heating. Electric heaters can serve as standby or auxiliary heat sources. The vehicle-mounted storage tank 18 can be a standard high-pressure hydrogen tank rated at 35 MPa or 70 MPa. Cryogenic liquids such as liquid nitrogen or liquefied natural gas can also be used as the working medium. The electric motor 3 can also be replaced with a hydraulic driving device.

The technical solutions and beneficial effects of the present invention have been detailed through the above embodiments. It should be understood that these embodiments are merely specific examples and do not limit the scope of the invention. Any modifications, supplements, and equivalent replacements made within the principles of the present invention should be considered within the scope of its protection.

What is claimed is:

1. A liquid hydrogen pressurization and refueling system synergistically driven by power and heat, comprising a liquid hydrogen storage tank (1), a reciprocating liquid hydrogen pump (4), and a cascaded cryogenic and high-pressure vessel group, the cascaded cryogenic and high-pressure vessel group includes at least four cryogenic and high-pressure vessels (6) of identical structures;
each cryogenic and high-pressure vessel (6) is equipped with an input pipeline, an output pipeline, and a return pipeline, additionally, an in-tank heat exchanger (15) is installed inside the cryogenic and high-pressure vessel (6);
each input pipeline is connected to an input main pipe via an input regulating valve (5), each output pipeline is connected to the output main pipe via an output regulating valve (7), each return pipeline is connected to a return main pipe via a return regulating valve (8), an inlet end of each in-tank heat exchanger (15) is connected to a heat exchanger main input pipe via a heat exchanger regulating valve (14), and an outlet end is connected to a heat exchanger main output pipe;
one end of the input main pipe connects to an outlet of the liquid hydrogen storage tank (1) via the reciprocating liquid hydrogen pump (4), while the other end is equipped with an input main pipe safety valve (9);
one end of the return main pipe connects to the inlet of the liquid hydrogen storage tank (1) via a main return regulating valve (20), and the other end is equipped with a return main pipe safety valve (10);
an tail end of the output main pipe is sequentially connected to a first three-way valve (11), a second three-way valve (12), and a first air heat exchanger (13), an outlet of the first air heat exchanger (13) and a bypass of the second three-way valve (12) are joined and then connected to the heat exchanger main input pipe;
a bypass of the first three-way valve (11) and the tail end of the heat exchanger main output pipe are combined into the filling pipeline, the filling pipeline is sequentially connected to a third three-way valve (16) and a second air heat exchanger (17), an outlet of the second air heat exchanger (17) and a bypass of the third three-way valve (16) are joined and then connected to the vehicle-mounted storage tank (18).

2. The liquid hydrogen pressurization and refueling system synergistically driven by power and heat of claim 1, wherein, the liquid hydrogen storage tank (1) equipped with a liquid hydrogen storage tank safety valve (2), and the vehicle-mounted storage tank (18) is equipped with a discharging regulating valve (19).

3. The liquid hydrogen pressurization and refueling system synergistically driven by power and heat of claim 1, wherein, the liquid hydrogen storage tank (1) equipped with a pressure sensor, each cryogenic and high-pressure vessel (6) and the vehicle-mounted storage tank (18) are equipped with temperature and pressure sensors, while temperature sensors are installed at both the front and rear of each in-tank heat exchanger (15).

4. The liquid hydrogen pressurization and refueling system synergistically driven by power and heat of claim 1, wherein, the cascaded cryogenic and high-pressure vessel group comprising four cryogenic and high-pressure vessels (6), three of the cryogenic and high-pressure vessels are used for the cascaded filling of the vehicle-mounted storage tank (18) and correspond to high-pressure, medium-pressure, and low-pressure filling vessels, respectively; the remaining cryogenic and high-pressure vessel is used for the pressurization process, in this process, liquid hydrogen from the liquid hydrogen storage tank (1) is pressurized and filled into the cryogenic and high-pressure vessel via the reciprocating liquid hydrogen pump (4) until the pressure rises to 30-50 MPa, then, the liquid hydrogen undergoes equal-capacity thermal compression to 80-100 MPa using the in-tank heat exchangers (15);
during the process of equal-capacity thermal compression to 80-100 MPa, thermal compression of the cryogenic and high-pressure vessel (6) is achieved by the hydrogen flow filling the vehicle-mounted storage tank (18) from the cryogenic and high-pressure vessels (6) in the filling process.

5. The liquid hydrogen pressurization and refueling system synergistically driven by power and heat of claim 4, wherein, the specific process of the equal-capacity thermal compression to 80-100 MPa is as follows:
initially, filling is carried out using the cryogenic and high-pressure vessel (6) with the lowest pressure among those in the filling process, supercritical hydrogen flows through the output regulating valve (7) into the first air heat exchanger (13), where it is heated close to ambient temperature, subsequently, the supercritical hydrogen enters the in-tank heat exchanger (15) of the cryogenic and high-pressure vessel (6) in the pressurization process via the heat exchanger regulating valve (14), the process achieves equal-capacity pressurization of the cryogenic and high-pressure vessel (6) in the pressurization process until its pressure reaches 80-100 MPa;
after the supercritical hydrogen exits the in-tank heat exchanger (15), the supercritical hydrogen flow is heated to the temperature required by filling through the third three-way valve (16) and the second air heat exchanger (17), and then it fills the vehicle-mounted storage tank (18); the output temperature of the first air heat exchanger (13) is regulated using the second three-way valve (12); once the cryogenic and high-pressure vessel (6) in the pressurization process reaches 80-100 MPa, the hydrogen flow for filling is directly guided to the in-tank heat exchanger (15) via the first three-way valve (11).

6. The liquid hydrogen pressurization and refueling system synergistically driven by power and heat of claim 5, wherein, when the pressure of the cryogenic and high-pressure vessel used for high-pressure filling is lower than the upper pressure limit required for filling the vehicle-mounted storage tank, or when the pressure of the cryogenic and high-pressure vessel used for low-pressure filling is lower than the lower pressure limit required for filling the vehicle-mounted storage tank, the functions of the four cryogenic and high-pressure vessels are simultaneously adjusted, the original cryogenic and high-pressure vessel in the pressurization process becomes the high-pressure filling vessel, the original high-pressure filling vessel becomes the medium-pressure filling vessel, the original medium-pressure filling vessel becomes the low-pressure filling vessel, the original low-pressure filling vessel enters the pressurization process; by coupling the pressurization process and the cascaded filling process, synchronization of the pressurization and the filling cycle of the cryogenic and high-pressure vessels (6) is achieved, enabling continuous and rapid pressurization filling.

7. The liquid hydrogen pressurization and refueling system synergistically driven by power and heat of claim 1, wherein, each in-tank heat exchanger (15) is either a wound pipe outside an inner tank of the cryogenic and high-pressure vessel or is embedded into the inner tank of the cryogenic and high-pressure vessel and designed as a finned-pipe heat exchanger or a corrugated-pipe heat exchanger.

8. The liquid hydrogen pressurization and refueling system synergistically driven by power and heat of claim 1, wherein, the reciprocating liquid hydrogen pump (4) is a 30-50 MPa liquid hydrogen pump driven by an electric motor or hydraulic pressure.
